(19) United States
(12) Patent Application Publication
(10) Pub. No.: US 2010/0014758 A1
(43) Pub. Date: Jan. 21, 2010

(54) METHOD FOR DETECTING PARTICULAR OBJECT FROM IMAGE AND APPARATUS THEREOF

(75) Inventors: Kotaro Yano, Tokyo (JP); Yasuhiro Ito, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/502,921

(22) Filed: Jul. 14, 2009

(30) Foreign Application Priority Data
Jul. 15, 2008 (JP) 2008-184253

(51) Int. Cl. G06K 9/46

(52) U.S. Cl. 382/195; 382/118

(57) ABSTRACT

When discriminating a plurality of types of objects, a plurality of local feature quantities are extracted from local regions in an image, and positions of the local regions, and attributes according to image characteristics of the local feature quantities are stored in correspondence with each other. Then, object likelihoods with respect to a plurality of objects are determined from attributes of feature quantities in a region-of-interest, an object whose object likelihood is not less than a threshold value is determined as an object candidate, and whether an object candidate is a predetermined object is determined.

### BACKGROUND OF THE INVENTION

1. Field of the Invention

The present invention relates to an image processing method for detecting a particular object pattern from an image, and to an apparatus thereof.

2. Description of the Related Art

An image processing method for automatically detecting a particular object pattern from an image is very useful, which can be utilized for identification of, for example, human faces. Such an image processing method can be used in a wide variety of fields such as video-conference, man-machine-interface, security system, monitor-system for tracking human faces, and an image compression.

Of such image processing methods, as a technique to detect a face from an image, various methods are discussed in the Document 1 (Yang et al, “Detecting Faces in Images: A Survey”, IEEE TRANSACTIONS ON PATTERN ANALYSIS AND MACHINE INTELLIGENCE, VOL. 24, NO. 1, JANUARY 2002).

In the Document 1, a method for detecting human faces is illustrated by utilizing several noticeable features (two eyes, mouth, nose), and specific geometric positional relationship between features. Furthermore, in the Document 1, a method for detecting human faces by utilizing symmetrical features of human faces, color features of the human faces, template matching, neural network, and the like is also discussed.

Furthermore, a method for detecting face patterns in images by a neural network is discussed in the Document 2 (Rowley et al, “Neural network-based face detection”, IEEE TRANSACTIONS ON PATTERN ANALYSIS AND MACHINE INTELLIGENCE, VOL. 20, NO. 1, JANUARY 1998). Hereinbelow, a face detection method discussed in the Document 2 will be described in brief.

First, images to be detected of face patterns are written in a memory, and a predetermined region that is collated with a face is cut out from the written image. Then, a calculation is executed by a neural network taking a distribution (image pattern) of pixel values of the cut out region as an input, to obtain one output.

In this process, weights and threshold values of the neural network are learnt in advance via enormous amounts of face image patterns and non-face image patterns. Based on contents of the learning process, for example, if an output of the neural network is 0 or more, a pattern is discriminated as a face, otherwise, discriminated as a non-face.

Furthermore, in the Document 2, cutout locations of image patterns to be collated with faces, which serve as inputs of the neural network, are scanned in sequence both vertically and horizontally over the whole region of an image, for example, as illustrated in FIG. 3, and the image is cut out at each cutout location. Then, faces are detected out of the images by discriminating whether an image pattern is a face in a manner as described above for each of image patterns of the cutout images.

Further, to deal with detection of faces in various sizes, as illustrated in FIG. 3, images written in the memory are reduced in sequence in a predetermined percentage, and the above-described scanning, cutout, and discrimination is performed with respect to these images.

Further, as a method which focuses attention to higher-speediness of processing for detecting face patterns, there is a method discussed in the Document 3 (Viola and Jones, “Rapid Object Detection using Boosted Cascade of Simple Features”, Proceedings of the IEEE Conference on Computer Vision and Pattern Recognition (CVPR'01)). In the Document 3, a lot of weak discriminators are effectively combined using AdaBoost to enhance accuracy of face discrimination, and respective weak discriminators are constructed by Haar-like rectangle feature quantities, and further calculation of rectangle feature quantities is performed very rapidly utilizing integral images.

Further, discriminators obtained by the AdaBoost are connected in series, which form a cascade-structure face detector. First, this cascade-structure face detector removes candidates of apparently non-face patterns on the spot using previous-stage simple (i.e., with smaller calculated amount) discriminators. Then, it is determined whether an object is a face using subsequent-stage complex (namely, with larger calculated amount) discriminators having a higher identification performance with respect to only candidates other than non-face patterns.

Since it is not thus necessary to perform complicated determination for all candidates, processing for detecting face patterns become very fast.

However, in such a conventional technology, it is possible to perform discrimination with an accuracy enough to put it into practical use. On the other hand, however, there is a problem that processing amount needed to discriminate a particular object increases. Furthermore, since the most part of necessary processing is varied depending on each object, there is a problem that, when recognizing a plurality of objects, the amount of processing will become enormous.

If the method discussed in the Document 3, for example, is utilized for recognition of a plurality of objects, feature quantity to be calculated for each object is varied, even if candidates of respective objects have been reduced down by the previous simple discriminators. Accordingly, when the number of recognition targets becomes large, the amount of processing will result in becoming enormous.

In particular, in the case of analyzing one frame of an image, and performing categorization or retrieval of the image according to the contents of objects, discriminations of a plurality of objects becomes essential. As a consequence, it becomes very important to solve such a problem.

On the other hand, as a method for performing discrimination of objects from an image, a method that uses feature quantity of local region is discussed in the Document 4 (Csurka et al, “Visual categorization with bags of keypoints”, Proceedings of the 8^{th} European Conference on Computer Vision (ECCV' 04)). The method includes extracting a local region from an image based on a local luminance change, performing a clustering of feature quantity of the extracted local region, and totaling the results of the clustering to determine the presence of an object in the image.

In the Document 4, results of discriminations of various objects are illustrated, and calculations of the feature quantities of the local regions are conducted by the same method, even if targets to be discriminated are varied. Therefore, if a method in which such a local feature quantity is used for discrimination of an object is applied to recognition of a variety of objects, there is a possibility that common processing results will be obtained efficiently.

Further, in Japanese Patent Application Laid-Open No. 2005-63309, the following method is discussed. First, the entire region of an image is divided, and the divided regions are furthermore divided into blocks, and features such as color/edge and the like are extracted from each block.

Then, an attribute of an object is determined based on similarity between the extracted features and features specific to a plurality of objects, and attributes are totaled for each of the divided regions. The attribute of the object is determined using the totaled results. Even in such a method, feature quantity is calculated as a common processing, thereby performing discrimination of multiple types of objects.

However, in the methods described above as conventional techniques, feature quantity is determined from a local region, and discrimination of an object is performed according to its statistics. In such a method, there may be a possibility that discrimination of a plurality of types of objects is performed with a good efficiency, but there is a problem that discrimination accuracy may be lower.

### SUMMARY OF THE INVENTION

The present invention is directed to an image processing apparatus that discriminates a plurality of types of objects with a good efficiency, and with a high accuracy, and to a method therefor.

According to an aspect of the present invention, an image processing apparatus comprising, a first derivation unit configured to derive feature quantities in a plurality of local regions in an image, an attribute discrimination unit configured to discriminate respective attributes of the derived feature quantities according to characteristics of the feature quantities, a region setting unit configured to set a region-of-interest in the image, a second derivation unit configured to discriminate attributes of the feature quantities contained in the region-of-interest based on the attributes discriminated by the attribute discrimination unit, and to derive likelihoods with respect to a predetermined plurality of types of objects in the region-of-interest according to discriminated attributes, a dictionary selection unit configured to select a dictionary, from among a plurality of dictionaries set in advance, which represents a feature quantity specific to the object, according to the derived likelihoods, and an object discrimination unit configured to discriminate objects in the region-of-interest, based on the feature quantity specific to the object extracted from the selected dictionary, and the feature quantities in the region-of-interest.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a schematic configuration of an image processing apparatus according to an exemplary embodiment.

FIG. 2 is a flowchart illustrating a processing procedure of the image processing apparatus.

FIG. 3 illustrates a method for setting a region-of-interest (ROI).

FIG. 4 illustrates local regions.

FIGS. 5A and 5B illustrate multiple resolution image obtained through a reduction processing, and an attribute map corresponding thereto.

FIG. 6 illustrates an attribute within the ROI.

FIG. 7 illustrates a table representing an object probability model in a graphical form.

FIG. 8 is a block diagram illustrating a configuration of an object discrimination unit.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

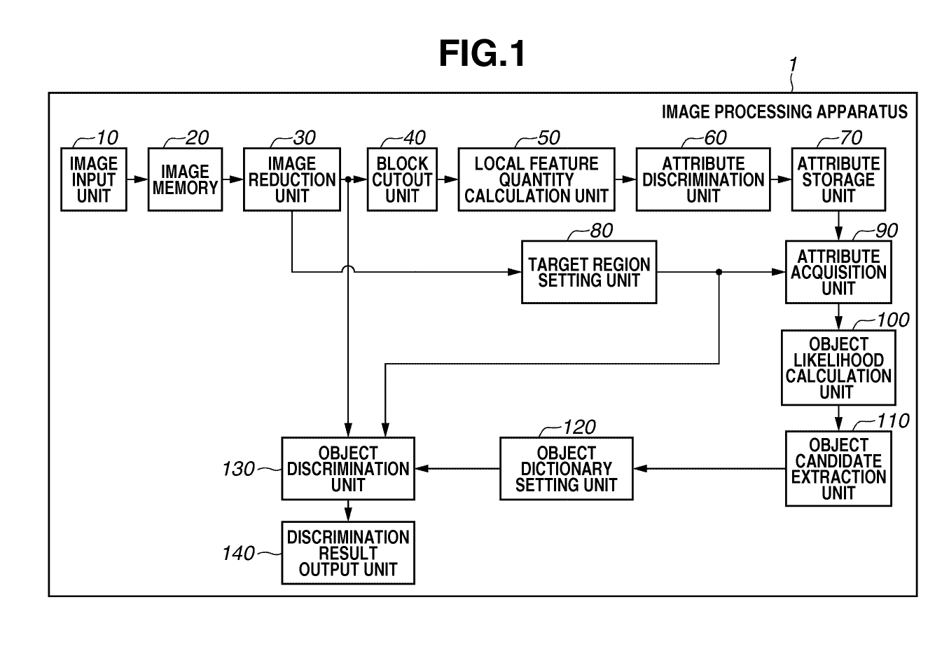

FIG. 1 is a block diagram illustrating an example of a schematic configuration of an image processing apparatus.

In FIG. 1, an image input unit 10 includes, for example, a digital still camera, a cam coder (shooting unit and recording unit are formed in one apparatus), and a film scanner. Image data is input through an imaging or other publicly known methods.

Alternatively, the image input unit 10 may be constituted by interface devices of a computer system, which have functions for reading out image data from a storage medium that stores digital image data. The image input unit 10 may be constituted by devices like “imaging unit of digital still camera” including a lens, and an image sensor such as a charge coupled device (CCD) or a complementary metal oxide semiconductor (CMOS) image sensors.

An image memory 20 temporarily stores image data output from the image input unit 10. An image reduction unit 30 reduces image data stored in the image memory 20 by a predetermined scale factor, and stores them. A block cutout unit 40 extracts a predetermined block as a local region from the image data reduced by the image reduction unit 30. A local feature quantity calculation unit 50 calculates a feature quantity of the local region extracted by the block cutout unit 40. An attribute discrimination unit 60 stores an attribute dictionary which was obtained in advance through a learning process, and discriminates an attribute of the local feature quantity calculated by the local feature quantity calculation unit 50, referring to the attribute dictionary. An attribute storage unit 70 stores attributes, which are results discriminated by the attribute discrimination unit 60, and locations of image data cut out by the block cutout unit 40 in association with each other.

A ROI setting unit 80 sets a region in an image to be subjected to discrimination of an object (hereinafter, referred to as a ROI as necessary). An attribute acquisition unit 90 acquires attributes within the ROI, which is set by the ROI setting unit 80 from the attribute storage unit 70.

An object likelihood calculation unit 100 stores a probability model between attributes and a predetermined object that is obtained in advance through learning process, and applies the probability model to the attributes acquired by the attribute acquisition unit 90, and calculates a likelihood of the object (hereinafter, referred to as an object likelihood).

An object candidate extraction unit 110 narrows down candidates for discriminating to which object the ROI set by the ROI setting unit 80 corresponds, using “object likelihoods in a plurality of discrimination targets” obtained by the object likelihood calculation unit 100.

An object dictionary setting unit 120 stores a plurality of the object dictionaries, which are obtained in advance through learning process, and sets an object dictionary corresponding to an object to be discriminated from among a plurality of object dictionaries to an object discrimination unit 130, according to candidates extracted by the object candidate extraction unit 110.

The object discrimination unit 130 refers to an object dictionary set by the object dictionary setting unit 120, and calculates the feature quantity of the object, from the image data corresponding to the ROI set by the ROI setting unit 80. Then, the object discrimination unit 130 discriminates whether an image pattern of the ROI set by the ROI setting unit 80 is a predetermined object.

A discrimination result output unit 140 outputs an object corresponding to the ROI set by the ROI setting unit 80, according to the discriminated result by the object discrimination unit 130. An operation of respective blocks illustrated in FIG. 1 is controlled by a control unit (not illustrated).

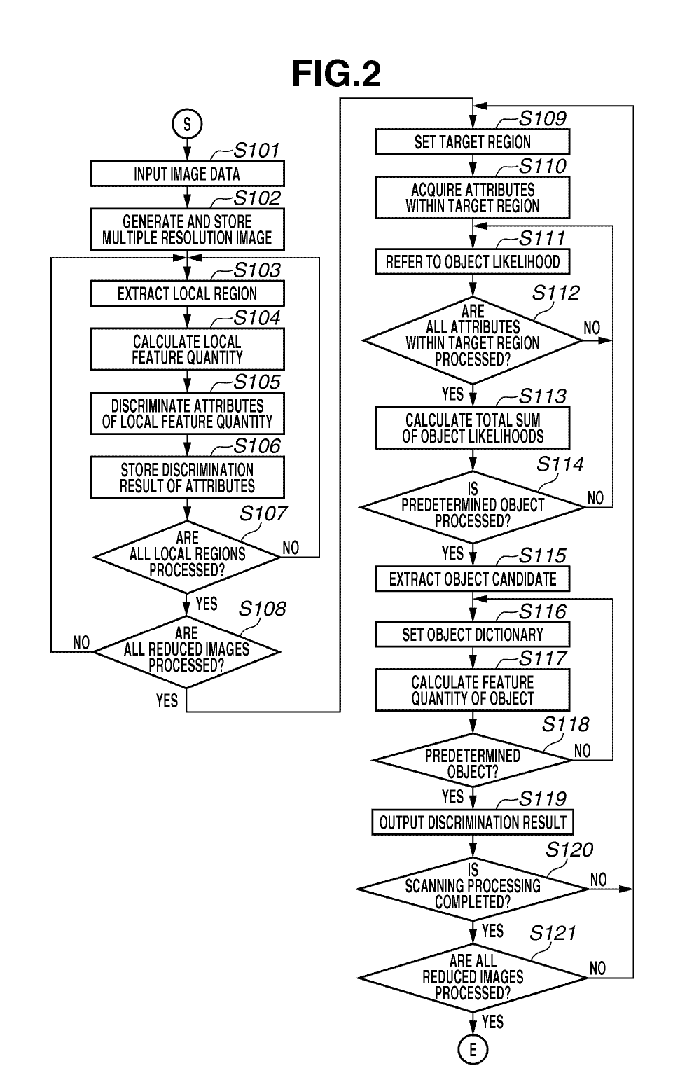

Next, an example operation of the image processing apparatus 1 will be described below referring to a flowchart in FIG. 2.

First, in step S101, the image input unit 10 obtains desired image data and writes in the image memory 20. The image data written in the image memory 20 is, for example, two-dimensional array data composed of, for example, 8-bit pixels including three faces of R, G, and B.

At this time, if the image data is compressed by a method such as joint photographic experts group (JPEG), the image input unit 10 decodes the image data in accordance with a predetermined decompression method, to convert it to the image data composed of respective pixels of RGB.

Furthermore, in the present exemplary embodiment, image data of RGB is transformed into luminance data, and the luminance data is used to a subsequent processing. Therefore, in the present exemplary embodiment, the image data stored in the image memory 20 is luminance data.

When data of YCrCb is input as image data, the image input unit 10 may be designed to write data of Y component as it is, as luminance data in the image memory 20.

Next, in step S102, the image reduction unit 30 reads out the luminance data from the image memory 20, and reduces the read out luminance data by a predetermined scale factor, to generate and store multiple resolution images. In the present exemplary embodiment, to deal with the detection of objects with various sizes, in a similar manner to the Document 2, the objects are detected in sequence from the image data (luminance data) of a plurality of sizes.

A reduction processing for generating a plurality of image data (luminance data) by varying scale factors, for example, by the order of 1.2 times is applied in sequence for the processing to be executed by subsequent blocks.

Next, in step S103, the block cutout unit 40 extracts a block of a predetermined size as a local region from the luminance data reduced in step S102.

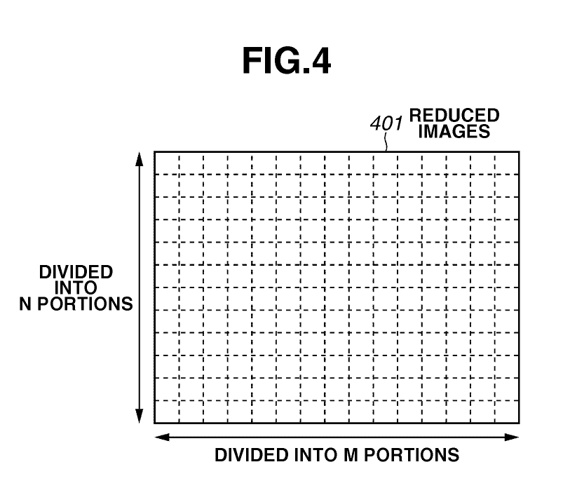

For example, FIG. 4 illustrates an example of a local region. As illustrated in FIG. 4, the block cutout unit 40 divides a reduced image 401 based on reduced luminance data vertically into N parts, horizontally into M parts (N, M are natural numbers, and at least one of them is 2 or more), thus dividing into (N×M) pieces of blocks (local regions).

FIG. 4 illustrates an example when the reduced image 401 is divided so that the blocks (local regions) may not overlap one another. However, the reduced image 401 may be divided so that the blocks partially overlap one another, to extract the blocks.

Next, in step S104, the local feature quantity calculation unit 50 calculates a local feature quantity with respect to each of the local regions extracted by the block cutout unit 40.

The local feature quantity can be calculated by a method discussed in, for example, the Document 5 (Schmid and Mohr, “Local Grayvalue Invariants for Image Retrieval”, IEEE Transactions on Pattern Analysis and Machine Intelligence, Vol. 19, No. 5 (1997)). That is, a result of sum-of-products calculation executed with respect to image data (luminance data) of a local region is determined as a local feature quantity, using Gaussian function and Gaussian derivatives as a filter coefficient.

Further, as discussed in the Document 6 (Lowe, “Object recognition from local scale-invariant features”, Proceedings of the 7^{th} International Conference on Computer Vision (ICCV99)), a local feature quantity may be determined, using a histogram in an edge direction. As the local feature quantity, “the ones having invariance to rotation of an image (geometric transformation) as discussed in these Documents 5, 6 are preferable.

Further, in the Document 7 (Mikolajczyk and Schmid, “Scale and Affine invariant interest point detectors”, International Journal of Computer Vision, Vol. 60, No. 1 (2004)), a feature quantity invariant to an affine transformation of an image is also discussed. When an object as viewed from different directions is discriminated, the use of invariant feature quantities with respect to such affine transformations is more preferable.

Further, in the above steps S103 and step S104, the case in which image data (luminance data) is divided into multiple blocks (local regions), and local feature quantities are calculated for each block is described taking it as an example. However, a method discussed, for example, in the Document 4 may be used.

In other words, interest points with better repeatability are extracted by a Harris-Laplace method from the image data (luminance data), and neighboring regions of the interest points are defined by scale parameters. Thus, local feature quantities may be extracted using the defined contents.

Next, in step S105, the attribute discrimination unit 60 refers to attribute dictionaries obtained in advance through the learning process, to discriminate attributes of the local feature quantities. In other words, when letting a local feature quantity extracted from each block (local region) to be χ, a representative feature quantity of each attribute stored in the attribute dictionary to be χₖ, the attribute discrimination unit 60 determines a Mahalanobis distance d between the local feature quantity and representative feature quantity of each attribute by the following Equation (1). Then, an attribute whose Mahalanobis distance d is the smallest is regarded as an attribute of the local feature quantity χ.

d =\sqrt{(x−xₖ)^{t}Σ⁻¹(x−xₖ)} (1)

Where, Σ in the Equation (1) is a covariance matrix of feature quantity spaces. Covariance matrix Σ of the feature quantity spaces is determined using a distribution of the local feature quantities acquired in advance from a multitude of images. Then, the covariance matrix Σ of the determined feature quantity spaces is stored in advance in the attribute dictionary, which is to be used in the step S105.

Further, in addition to these, representative feature quantity χₖ of each attribute is stored in the attribute dictionary by the number of the attributes. The representative feature quantity χₖ of each attribute is determined by performing a clustering K-means method, with respect to the local feature quantities acquired in advance from a multitude of images.

Discriminations of attributes of the local feature quantities are performed by the Mahalanobis distance d, as described by the Equation (1), however, it is not limited to this.

Discrimination of attributes of the local feature quantities may be performed by another standard such as, for example, a Euclidean distance. Further, in creating the attribute dictionary, a clustering of the local feature quantities is performed by using the K-means method, but the clustering of the local feature quantities may be performed using another clustering technique.

Next, in step S106, the attribute storage unit 70 stores “attributes of local feature quantities” determined in step S105, associating with locations of local regions where the local feature quantities were obtained. The locations of the local regions (image data) are extracted by the block cutout unit 40.

Next, in step S107, the control unit determines whether all local regions (blocks) divided in step S103 are processed. If all local regions (blocks) are not processed (NO in step S107), the process returns to step S103, and a next local region (block) is extracted.

Then, if the processing of all local regions (blocks) is completed (YES in step S107), then in step S108, the control unit determines whether all reduced images obtained in step S102 are processed.

If all reduced images are not processed (NO in step S108), then the process returns to step S103, and a next reduced image is divided into (N×M) pieces of local regions (blocks), and one out of them is extracted.

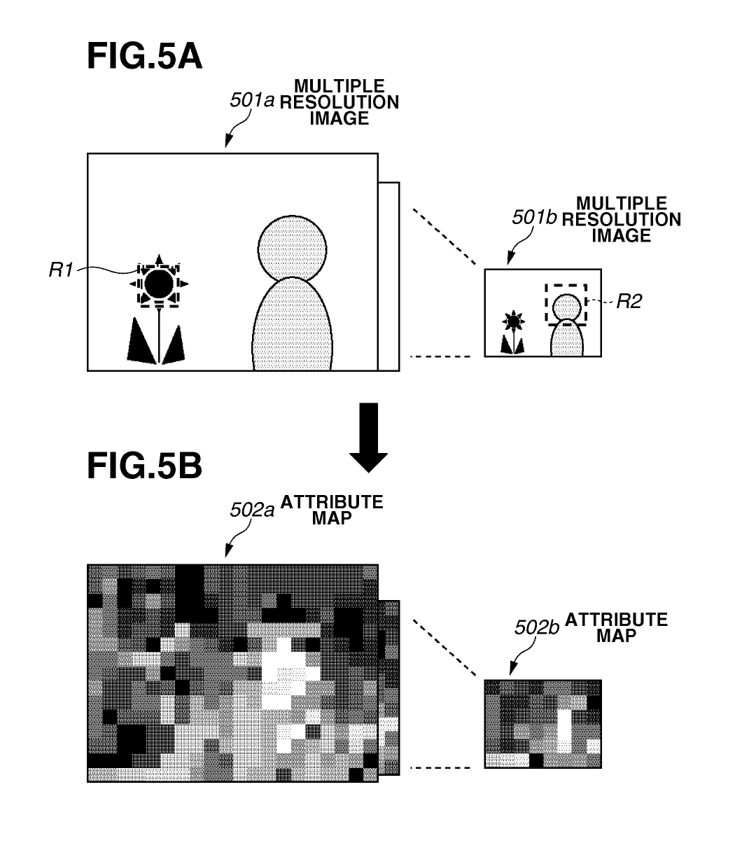

Then, if the processing of all reduced images is completed (YES in step S108), a multiple resolution image 501 (reduced image) obtained through a reduction processing in step S102, and an attribute map 502 corresponding thereto are obtained, as illustrated in FIGS. 5A and 5B, respectively.

In the present exemplary embodiment, the attribute map 502 is stored in the attribute storage unit 70. A class of attribute of local feature quantity may be set by assigning a predetermined integer value to an attribute of each local feature quantity as an index value. However, in FIGS. 5A and 5B, the case where the value is expressed by a luminance of an image is illustrated as an example.

Next, in step S109, the ROI setting unit 80 repeats scanning processes in sequence in vertical and horizontal directions with respect to multiple resolution images (reduced images) obtained in step S102, and sets “regions (ROIs) in an image” where objects are discriminated.

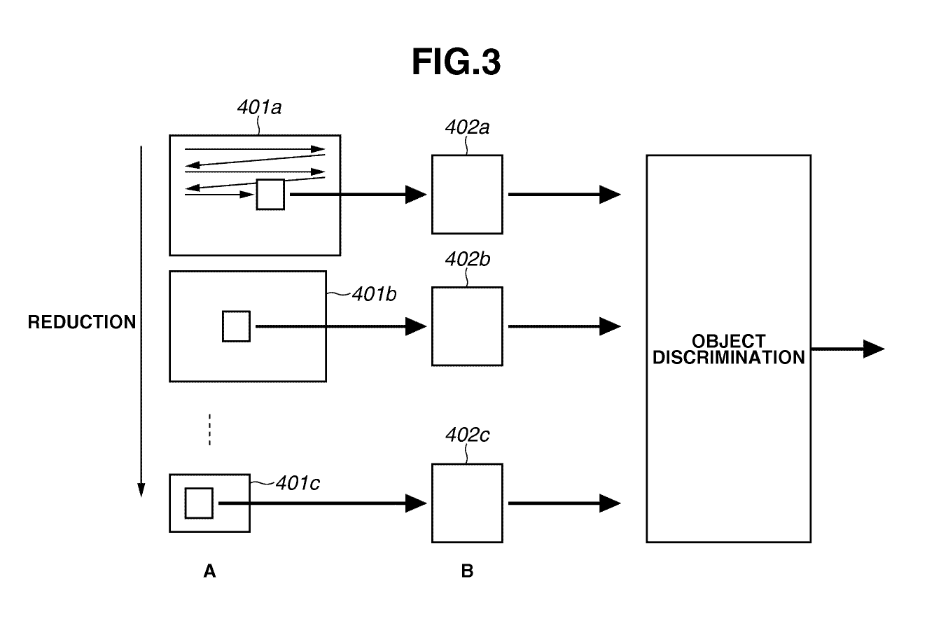

FIG. 3 is a diagram illustrating an example method for setting ROIs. In FIG. 3, column A illustrates “respective reduced images 401a to 401c” reduced by the image reduction unit 30. Rectangle regions of a predetermined size are to be cut out from respective reduced images 401a to 401c.

Column B illustrates ROIs 402a to 402c (collation patterns) cut out while repeating scanning processes in sequence in vertical and horizontal directions with respect to respective reduced images 401a to 401c.

As can be seen from FIG. 3, when the ROIs (collation patterns) are cut out from the reduced images with larger reduction ratios to discriminate the object, the detection of larger objects relative to a size of an image is performed.

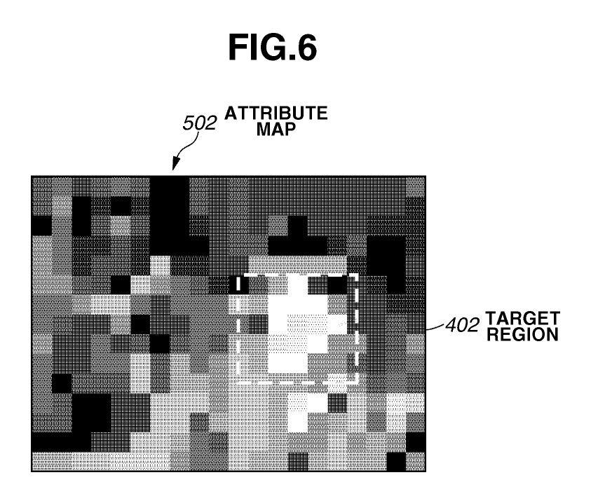

Next, in step S110, the attribute acquisition unit 90 acquires attributes within the ROI 402 set in step S109 from the attribute storage unit 70. FIG. 6 illustrates an example of attributes in the ROI 402. As illustrated in FIG. 6, from the ROI 402, a plurality of attributes corresponding thereto are extracted.

Next, in step S111, the object likelihood calculation unit 100 refers to an object likelihood from “attributes in the ROI 402” extracted in step S110. In other words, in the object likelihood calculation unit 100, an object probability model, which represents a likelihood of each attribute with respect to a predetermined object, is stored in advance as a table. The object likelihood calculation unit 100 refers to the table, to acquire object likelihoods corresponding to attributes within the ROI 402.

Contents of the table representing the object probability model are determined in advance object-by-object through the learning process. The learning of the table representing the object probability model may be performed, for example, in a manner as described below.

First, local feature quantities obtained from regions in an object to be a discrimination target is determined from among a multitude of images. Then, a value of +1 is added to each attribute obtained from a result of discrimination of attributes of the local feature quantities, thus creating an attribute-specific histogram.

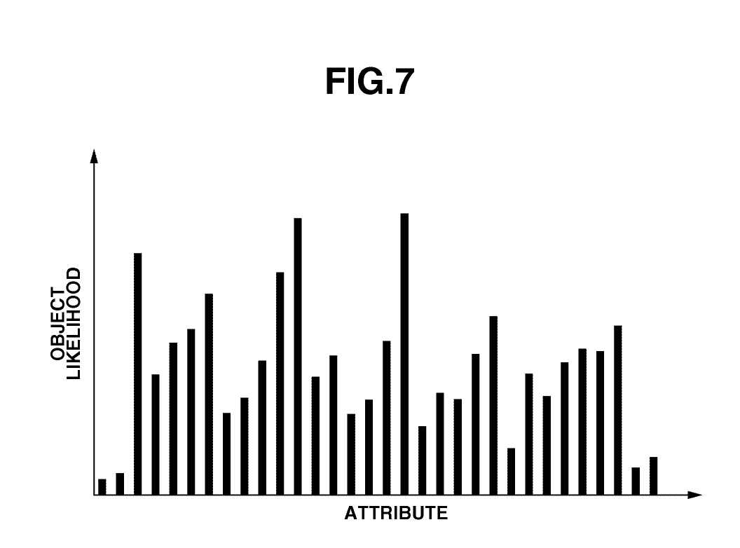

Then, a table is created by normalizing so that a total sum of created attribute-specific histogram is equal to a predetermined value. FIG. 7 illustrates an example table representing an object probability model in a graphical form.

Next, in step S112, the control unit determines whether object likelihoods are referred to, from all attributes within the ROI 402 set in step S109. If the object likelihoods are not referred to from all attributes within the ROI 402 (NO in step S112), then the process returns to step S111, and object likelihoods are referred to from a next attribute.

Then, if object likelihoods are referred to from all attributes within the ROI 402 (YES in step S112),the object likelihood calculation unit 100 determines a total sum of the object likelihoods within the ROI 402, in step S113, and sets the total sum of determined object likelihoods to be the object likelihood of the ROI 402.

Let each attribute to be νᵢ, an object to be discriminated to be C, a ROI of reduced image to be R, and when a luminance pattern of the object contains N feature quantities, a probability that the i-th feature quantity has an attribute νᵢ to be P(νᵢ|C), probability of occurrence of an object to be P(C). Then, probability P(C|R) that a ROI R is an object C can be expressed as in the following Equation (2).

$$P ( C \vert R ) = P ( C ) {\prod }_{i = 1}^{N} P ( {v}_{i} \vert C ) \qquad ( 2 )$$

Furthermore, a likelihood that a luminance pattern of an object has an attribute vi is defined as Lᵢ(=Lᵢ(νᵢ|C)=−lnP(νᵢ|C)). Then, when probabilities of occurrences of the objects are neglected by assuming that probabilities of occurrences of objects have no differences between the objects, a likelihood that a ROI R is an object C can be expressed as in the following Equation (3).

$$L ( C \vert R ) = {\sum }_{i = 1}^{N} {L}_{i} \qquad ( 3 )$$

Next, in step S114, the control unit determines whether a predetermined plurality of objects (e.g., all objects) are processed. If the predetermined plurality of objects are not processed (NO in step S114), the process returns to step S111, then, an object likelihood of a next object is referred to.

Then, if a predetermined plurality of objects are processed, and object likelihoods of the plurality of objects are determined (YES in step S114), the object candidate extraction unit 110 compares the object likelihoods of the plurality of objects with a predetermined threshold value.

Then, in step S115, the object candidate extraction unit 110 extracts objects whose object likelihoods are not less than the threshold value as object candidates. At this time, the object candidate extraction unit 110 performs sorting in descending order of the object likelihood, and creates a list of the object candidates in advance.

For example, in a ROI R1 of a reduced image 501a illustrated in FIG. 5A, an object that includes a flower or a feature quantity in common with a flower is extracted as an object candidate. Further, in a ROI R2 of a reduced image 501b, an object that includes a face or a feature quantity in common with a face is extracted as an object candidate.

Next, in step S116, the object dictionary setting unit 120 sets an object dictionary corresponding to an object to be discriminated, from among a plurality of object dictionaries obtained in advance through the learning process, to the object discrimination unit 130, according to a list created in step S115.

In the object dictionary, for example, an object, and feature quantity specific to the object are set in correspondence with each other.

Next, in step S117, the object discrimination unit 130 refers to an object dictionary set in step S116, and calculates “feature quantity specific to object” in the image pattern of the ROI 402.

Next, in step S118, the object discrimination unit 130 collates the “feature quantity specific to object” calculated in step S117 with the feature quantity of the ROI 402 in the reduced images 401 to be processed, and determines whether an object candidate is a predetermined object according to a collation result.

In this process, an accuracy of a discrimination of the object is enhanced by combining effectively a number of weak discriminators, using AdaBoost as discussed in the Document 3, with respect to the image patterns.

In the Document 3, discriminators are constructed by combining outputs (results), assigning predetermined weights thereto, from weak discriminators, which discriminate an object according to a partial contrast (difference between adjacent rectangle regions (ROIs) each other) of ROIs, to discriminate the object. The partial contrast then represents a feature quantity of an object.

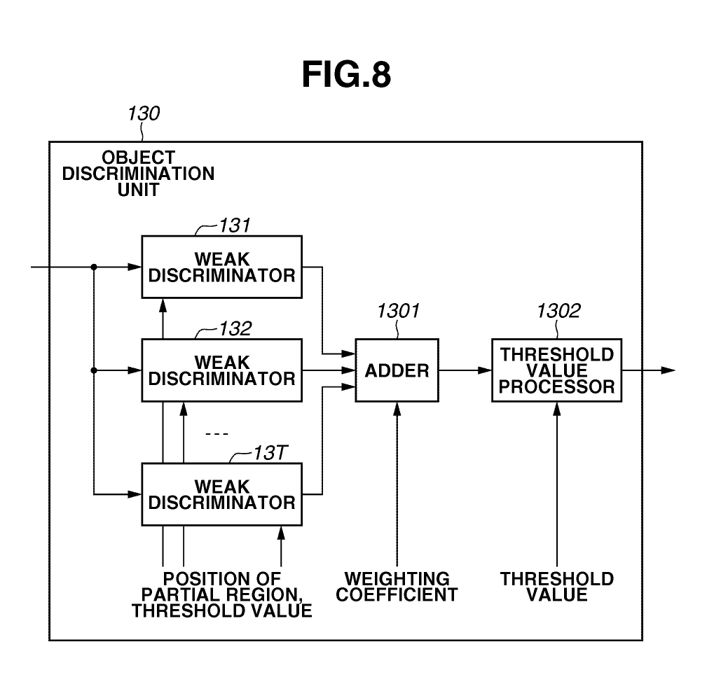

FIG. 8 illustrates an example configuration of the object discrimination unit 130.

In FIG. 8, the object discrimination unit 130 includes a plurality of weak discriminators 131, 132, . . . , 13T (combined discriminators), each of which calculates a partial contrast (feature quantity of an object), and discriminates an object by a threshold value processing from the calculated partial contrast.

Then, an adder 1301 performs a predetermined weighted calculation using a weighting coefficient with respect to outputs from the multiple weak discriminators 131, 132, . . . , 13T. A threshold value processor 133 discriminates an object by performing the threshold value processing with respect to the outputs from the adder 1301.

At this time, a position of a partial region within the ROI 402 where the partial contrast is calculated, a threshold value of the weak discriminator, a weight of the weak discriminator, a threshold value of combined discriminators are varied depending on an object. Therefore, an object dictionary corresponding to an object to be discriminated is set by the object dictionary setting unit 120.

At this time, as discussed in the Document 3, the object may be discriminated by combining the multiple combined discriminators in series. The more the number of combinations of weak discriminators, the higher the discrimination accuracy becomes, but more complex the processing becomes. Therefore, the combination of the weak discriminators needs to be adjusted in consideration of these factors.

A method for discriminating an object is not limited to the ones described above. For example, as discussed in the Document 2, an object may be discriminated using a neural network.

Further, in extracting a feature quantity of an object, not only an image pattern of the ROI 402, but also “attribute of a region corresponding to the ROI 402” output from the attribute acquisition unit 90 may be utilized.

Now in step S118 of FIG. 2, if it is determined that an object candidate is not a predetermined object (NO in step S118), the process returns to step S116. Then, an object dictionary corresponding to a next object candidate is set to the object discrimination unit 130, in accordance with a list created in step S115.

On the other hand, if it is determined that an object candidate is a predetermined object (YES in step S118), or, if it is determined that an object candidate is not a predetermined object, even though all of the object dictionaries are set, a discrimination processing of the object with respect to the ROI 402 set in step S109 is terminated. Then, information of determined result is output to a discrimination result output unit 140.

Then, in step S119, the discrimination result output unit 140 outputs an object corresponding to the ROI 402 set by the ROI setting unit 80 according to information output from the object discrimination unit 130. For example, the discrimination result output unit 140 displays an input image on a display, and displays a frame corresponding to the ROI and the object name so as to be superimposed on it.

Further, the discrimination result output unit 140 may save, and output a discrimination result of an object as auxiliary information of input image in association with each other. Alternatively, if an object candidate does not correspond to any object, the discrimination result output unit 140 may output, or may not output it, for example.

Next, in step S120, the control unit determines whether a scanning processing of reduced image 401 to be processed is completed. If the scanning of the reduced image 401 to be processed is not completed (NO in step S120), the process returns to step S109. In step S109, the process continues scanning to set a next ROI 402.

On the other hand, if the scanning of the reduced image 401 to be processed is completed (YES in step S120), then in step S121, the control unit determines all reduced images obtained in step S102 are processed. If all reduced images 401 are not processed (NO in step S121), the process returns to step S109. In step S101, the ROI 402 is set to a next reduced image 401.

Then, if the processing of all reduced images 401 is completed (YES in step S121), the processing according to a flowchart of FIG. 2 is terminated.

In this process, each time one ROI 402 is processed, a determination result is output (refer to steps S118, S119). However, it is not limited to this.

For example, in step S121, after the processing of all reduced images 401 is completed, a processing of step S119 may be performed.

In the present exemplary embodiment as described above, when a plurality of types of objects are discriminated, a plurality of local-feature quantities are extracted from one reduced image 401, and each of the local feature quantities, and attributes according to characteristics (image characteristics) of the local feature quantities are stored in correspondence with each other.

Then, object likelihoods of a plurality of objects is determined, from attributes of feature quantities of the ROI 402, and an object whose object likelihood is not less than a threshold value is determined as an object candidate, then whether an object candidate is a predetermined object is determined.

In other words, the number of objects, which are targets for performing discrimination based on appearance of an image (discrimination of an object according to feature quantity specific to object) is reduced down. As a result, discrimination of multiple types of objects can be performed with high accuracy. Further, calculations of the local feature quantities and association between the local feature quantities and their attributes are performed in a common processing without being dependent on classes of objects. Consequently, discriminations of a plurality of types of objects can be efficiently performed.

Further, attributes of the local feature quantities are stored in advance, associated with positions of images where the local feature quantities were obtained, and attributes of the local feature quantities can be acquired with respect to the ROI 402. Accordingly, detections of different objects in each image region can be performed.

In the present invention, they can be also implemented by causing a central processing unit (CPU) to read out and execute a program code of software which implements functions of the above-described exemplary embodiment from a computer-readable storage medium. Furthermore, they can be implemented by causing an operating system (OS) to execute a part or all of the processing according to instructions of the read out program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-184253 filed Jul. 15, 2008, which is hereby incorporated by reference herein in its entirety.

What is claimed is:

1. An image processing apparatus comprising:
a first derivation unit configured to derive feature quantities in a plurality of local regions in an image;
an attribute discrimination unit configured to discriminate respective attributes of the derived feature quantities according to characteristics of the feature quantities;
a region setting unit configured to set a region-of-interest in the image;
a second derivation unit configured to discriminate attributes of the feature quantities contained in the region-of-interest based on the attributes discriminated by the attribute discrimination unit, and to derive likelihoods with respect to a predetermined plurality of types of objects in the region-of-interest according to discriminated attributes;
a dictionary selection unit configured to select a dictionary, from among a plurality of dictionaries set in advance, which represents a feature quantity specific to the object, according to the derived likelihoods; and
an object discrimination unit configured to discriminate objects in the region-of-interest, based on the feature quantity specific to the object extracted from the selected dictionary, and the feature quantities in the region-of-interest.

2. The image processing apparatus according to claim 1, further comprising a storage unit configured to store attributes of feature quantities derived by the first derivation unit, and positions of the local regions corresponding to the attributes in association with each other,
wherein the second derivation unit reads out attributes stored in the storage unit associated with positions of the region-of-interest, and derives likelihoods in the region-of-interest with respect to a predetermined plurality of types of objects, from the read out attributes.

3. The image processing apparatus according to claim 1, wherein the dictionary selection unit selects a dictionary corresponding to an object whose likelihood derived by the second derivation unit is not less than a threshold value, and
wherein the object discrimination unit discriminates an object whose likelihood derived by the second derivation unit in the region-of-interest is not less than the threshold value.

4. The image processing apparatus according to claim 1, further comprising a division unit configured to divide the images into a plurality of blocks,
wherein the first derivation unit derives feature quantities in the blocks divided by the division unit.

5. The image processing apparatus according to claim 1, further comprising a reduction unit configured to reduce the images by a predetermined scale factor,
wherein the first derivation unit derives feature quantities in a plurality of local regions in the images reduced by the reduction unit,
wherein the region setting unit sets a region-of-interest in the images reduced by the reduction unit.

6. The image processing apparatus according to claim 1, wherein the first derivation unit derives invariant feature quantities with respect to geometric transformations.

7. An image processing method comprising:
deriving, from a plurality of local regions in an image, feature quantities in the local regions;
discriminating respective attributes of the derived feature quantities, according to characteristics of the feature quantities;
setting a region-of-interest in the image;
discriminating attributes of feature quantities contained in the set region-of-interest, according to attributes of feature quantities in the local regions,
deriving likelihoods with respect to a predetermined plurality of types of objects in the region-of-interest from discriminated attributes;
selecting a dictionary that represents a feature quantity specific to the object, according to the derived likelihoods, from among a plurality of dictionaries set in advance with respect to objects; and
discriminating an object in the region-of-interest, based on the feature quantity specific to the object extracted from the selected dictionary that was set, and feature quantities in the region-of-interest.

8. A computer-readable storage medium that stores a program for instructing a computer to implement an image processing method, the method comprising:
deriving, from a plurality of local regions in an image, feature quantities in the local regions;
discriminating respective attributes of the derived feature quantities, according to characteristics of the feature quantities;
setting a region-of-interest in the image;
discriminating attributes of feature quantities contained in the set region-of-interest, according to attributes of feature quantities in the local regions,
deriving likelihoods with respect to a predetermined plurality of types of objects in the region-of-interest from discriminated attributes;
selecting a dictionary that represents a feature quantity specific to the object, according to the derived likelihoods, from among a plurality of dictionaries set in advance with respect to objects; and
discriminating an object in the region-of-interest, based on the feature quantity specific to object extracted from the selected dictionary that was set, and feature quantities in the region-of-interest.
